(19) United States
(12) Patent Application Publication
(10) Pub. No.: US 2024/0315911 A1
(43) Pub. Date: Sep. 26, 2024

(54) COLLAPSIBLE WALKING DEVICE

(71) Applicant: Stander, Inc., Logan, UT (US)

(72) Inventors: Kip Alder, Nibley, UT (US); Dylan Papasian, Logan, UT (US)

(21) Appl. No.: 18/604,814

(22) Filed: Mar. 14, 2024

Related U.S. Application Data
(60) Provisional application No. 63/491,892, filed on Mar. 23, 2023.

(51) Int. Cl. A61H 3/04

(52) U.S. Cl. CPC A61H 3/04; A61H 2003/046; A61H 2201/0161

(57) ABSTRACT

A collapsible walking device that can be disposed in an operative configuration and a storage configuration. The collapsible walking device includes handles, legs, and first and second cross bars that couple the handles and legs. The collapsible walking device further includes a third cross bar that is pivotably coupled to the first and second cross bars and is configured to maintain a fixed angle between the first and second cross bars when the collapsible walking device is in the operative configuration.

### RELATED CASES

This application claims priority to U.S. Provisional Application No. 63/491,892, filed on Mar. 23, 2023 and titled “COLLAPSIBLE WALKING DEVICE,” which is hereby incorporated by reference in its entirety.

### TECHNICAL FIELD

The present disclosure relates generally to mobility assistance devices. More specifically, the present disclosure relates to walkers to assist individuals in standing or walking.

### BRIEF DESCRIPTION OF THE DRAWINGS

The embodiments disclosed herein will become more fully apparent from the following description and appended claims, taken in conjunction with the accompanying drawings. The drawings depict only typical embodiments, which embodiments will be described with additional specificity and detail in connection with the drawings in which:

FIG. 1A is a perspective view of a collapsible walking device in an operative configuration, according to one embodiment of the present disclosure.

FIG. 1B is a perspective view of a collapsible walking device in an operative configuration, according to one embodiment of the present disclosure.

FIG. 2 is a perspective view of a collapsible walking device in a storage configuration, according to one embodiment of the present disclosure.

FIG. 3A is a perspective detailed view of a cross bar of a collapsible walking device in an operative configuration, according to one embodiment of the present disclosure.

FIG. 3B is a perspective detailed view of the cross bar of the collapsible walking device of FIG. 3A transitioning from the operative configuration to a storage configuration, according to one embodiment of the present disclosure.

FIG. 3C is a top view of the cross bar of the collapsible walking device of FIG. 3A in an operative configuration.

FIG. 4A is a perspective detailed view of a locking mechanism of a collapsible walking device in an operative configuration, according to one embodiment of the present disclosure.

FIG. 4B is a perspective detailed view of a cross-section of gears of the locking mechanism within a housing, according to one embodiment of the present disclosure.

### DETAILED DESCRIPTION

It will be readily understood that the components of the embodiments as generally described and illustrated in the Figures herein could be arranged and designed in a wide variety of different configurations. Thus, the following more detailed description of various embodiments, as represented in the Figures, is not intended to limit the scope of the disclosure, but is merely representative of various embodiments While the various aspects of the embodiments are presented in drawings, the drawings are not necessarily drawn to scale unless specifically indicated.

The phrase “coupled to” is broad enough to refer to any suitable coupling or other form of interaction between two or more entities, including mechanical. Two components may be coupled to each other even though they are not in direct contact with each other.

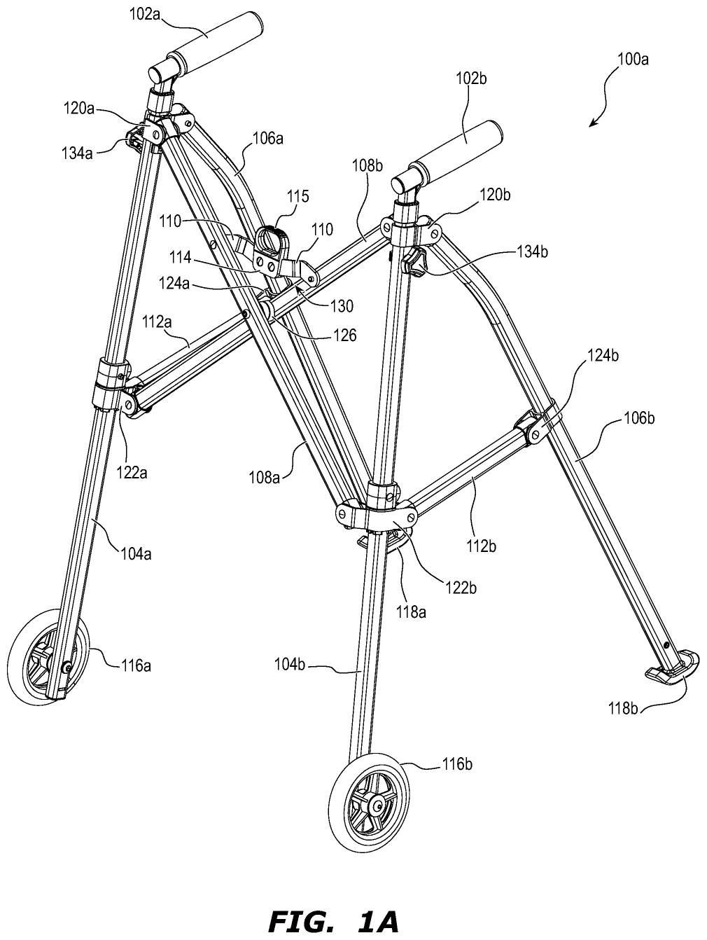

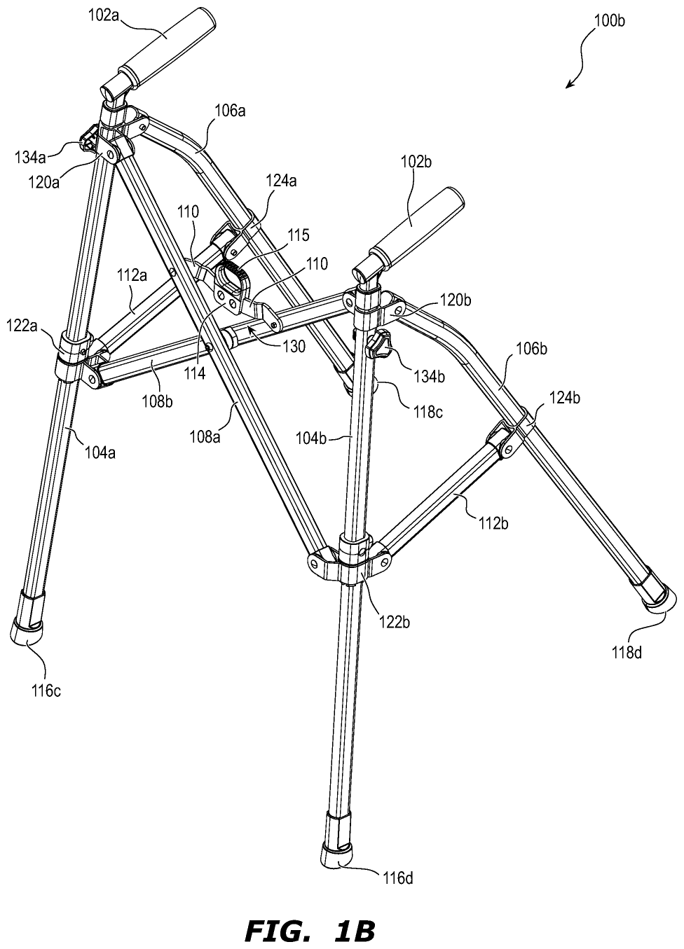

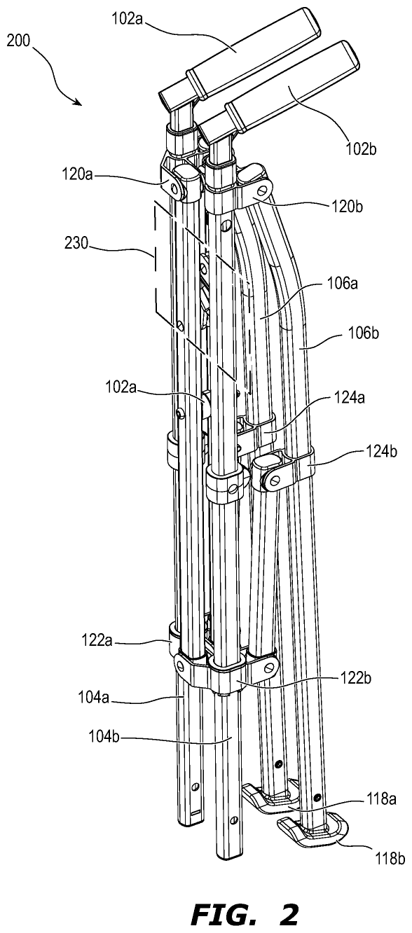

FIG. 1A is a perspective view of a collapsible walking device 100a in an operative configuration, according to one embodiment of the present disclosure. The collapsible walking device 100a is a collapsible walking device that can be configured in either an operative (open) configuration or a storage (closed) configuration. In the operative configuration, as shown in FIG. 1A, the collapsible walking device 100a may provide mobility support for a user. For example, the collapsible walking device 100a may provide assistance to a user for standing and/or walking. The storage configuration may allow for easy and convenient storage and efficient transportation the collapsible walking device 100a, as shown in FIG. 2.

The collapsible walking device 100a includes handles 102a and 102b, legs 104a, 104b, 106a, and 106b, cross bars 108a and 108b, and a cross bar 110. The legs 104a-b can be referred to as handle legs while the legs 106a-b can be referred to as support legs. The handles 102a and 102b allow the collapsible walking device 100a to be grasped by the user to support the user while standing or walking. The legs 104a and 104b extend away from the handles 102a and 102b, respectively. The legs 104a and 104b are handle legs that may extend away from the handles 102a and 102b and towards the ground, or other surface on which the collapsible walking device 100a may be located. The legs 106a and 106b extend away from the handles 102a and 102b or from the legs 104a and 104b, respectively. The legs 106a and 106b are support legs that may extend away from the handles 102a and 102b or from the legs 104a and 104b and towards the ground. For example, when the collapsible walking device 100a is being used by a user in the operative configuration (e.g., when the user is using the collapsible walking device 100a for assistance for standing or walking), the legs 104a and 104b are oriented in a forward position extending from the handles 102a and 102b, respectively, towards the ground away from the user in a direction that the user may wish to walk. Similarly, the legs 106a and 106b are oriented towards the user and opposite a direction that the user may wish to walk.

The collapsible walking device 100 includes a first lateral portion and a second lateral portion. In other words, the collapsible walking device 100 includes a right side and a left side. The first lateral portion may include a handle 102a, a handle leg 104a that extends away from the handle 102a, and a support leg 106a that extends away from the handle leg 104a. The second lateral portion may include a handle 102b, a handle leg 104b that extends away from the handle 102b, and a support leg 106b that extends away from the handle leg 104b.

More specifically, the legs 104a and 104b may extend towards the ground at a first angle away from the handle legs 104a and 104b. In some embodiments, the first angle can be defined with respect to a line formed orthogonal to the ground. The legs 106a and 106b may extend towards the ground at a second angle away from the handle legs 104a and 104b. The second angle can be measured with the line formed orthogonal to the ground, and is in an opposite angular direction from the first angle. In some embodiments, the magnitudes of the second angle and the first angle are different. In other embodiments, the magnitudes of the second angle may be the same. Although the first and second angles are described as being defined with respect to a line that is orthogonal to the ground, the first and second angles may be measured with respect a different reference line. For example, in some embodiments, a longitudinal direction of the legs 104a and 104b may be used as the reference, a longitudinal direction of the legs 106a and 106b may be used as the reference, a line substantially parallel to the ground may be used as a reference, etc.

The cross bars 108a and 108b intersect each other and are pivotably coupled to the other. In the illustrated embodiment, the cross bars 108a-b intersect each other at an intersection 126 and the cross bars 108a and 108b are pivotable about the intersection 126, which may serve as an axis of rotation. The cross bars 108a and 108b are further pivotably coupled to the legs 104a and 104b, respectively. Each of the cross bars 108a and 108b are pivotably coupled to the legs 104a and 104b at two different locations. Each of the legs 104a and 104b comprise a first end and a second end, the second end is opposite the first end. In the illustrated embodiment, the first end of the cross bar 108a is pivotably coupled to the leg 104a at/near the top of the leg 104a, and the second end of the cross bar 108b is slidably and pivotably coupled to the leg 104a at a position lower than the top of the leg 104a; simultaneously, the first end of the cross bar 108b is pivotably coupled to the leg 104b at/near the top of the leg 104b, the second end of the cross bar 108a is slidably and pivotably coupled to the leg 104b at a position lower than the top of the leg 104b. In this way, the cross bars 108a and 108b and the legs 104a and 104b may be folded to be substantially parallel when the collapsible walking device 100a is in the storage configuration as illustrated in FIG. 2.

The cross bar 110 is pivotably coupled to the cross bars 108a and 108b and can maintain a fixed angle between the cross bars 108a and 108b (e.g., at the pivot point between the cross bars 108a and 108b). The cross bar 110 maintains the fixed angle when the collapsible walking device 100a is in the operative configuration, such as to maintain stability of the collapsible walking device 100a when the user is standing or walking. In some embodiments, the cross bar 110 includes a locking mechanism 130 that is configured to maintain the fixed angle between the cross bars 108a and 108b. Additionally, as described with respect to FIG. 2, the cross bar 110 can maintain the collapsible walking device 110a in the storage configuration (e.g., by maintaining the angle between the cross bars 108a and 108b at a more acute angle than when the collapsible walking device 110a is in the operative configuration). Furthermore, the cross bar 110 can allow the collapsible walking device 100a to be transitioned between the operative configuration and the storage configuration by allowing the angle between the cross bars 108a and 108b to vary. In some embodiments, the locking mechanism 130 includes the cross bar 110 and a gear mechanism or a gear (not shown) for maintaining the fixed angle between the cross bars 108a and 108b as well as for transitioning of the collapsible walking device 100a between the operative and storage configurations.

In some embodiments, the locking mechanism 130 includes a housing 114 that encompasses a portion of the cross bar 110, which can encompass the gear mechanism. The housing 114 can also provide leverage, e.g., via a handle, gripping friction, pull tab, and the like for the user to fold or extend the cross bar 110 from the operative configuration and the storage configuration and vice versa. In the illustrated embodiment, the housing 114 may further include a handle 115 that may be gripped by the user so that user can provide leverage. The handle 115 of the housing 114 can allow the user of the collapsible walking device 100a to transition the collapsible walking device 100a between the operative configuration and the storage configuration.

In some embodiments, the collapsible walking device 100a further includes stabilization bars 112a and 112b. The stabilization bar 112a may be coupled between the legs 104a and 106a and the stabilization bar 112b may be coupled between the legs 104b and 106b. The stabilization bars 112a-b can provide additional support to maintain the collapsible walking device 100a in the operative configuration by forming a substantially triangular structure. For example, the stabilization bar 112a, leg 104a, and leg 106a may form a triangular structure and stabilization bar 112b, leg 104b, and leg 106b may form another triangular structure on opposing lateral sides of the collapsible walking device 100a. The stabilization bar 112a is pivotably coupled between the legs 104a and 106a and the stabilization bar 112b is pivotably coupled between the legs 104b and 106b. In some embodiments, the stabilization bar 112a is pivotably and slidably coupled between the legs 104a and 106a and the stabilization bar 112b is pivotably and slidably coupled between the legs 104b and 106b. In one embodiment, one end of the stabilization bar 112a and the second end of the cross bar 108a are pivotably coupled to the leg 104a at substantially the same location of the leg 104a. Similarly, one end of the stabilization bar 112b and the second end of the cross bar 108b are pivotably coupled to the leg 104b at substantially the same locations of the leg 104b. In some embodiments, one end of the stabilization bars 112a-b is pivotably fixed to one of the legs 104a-b and legs 106a-b and the opposing end of the stabilization bars 112a-b is pivotably and slidably coupled to one of the legs 104a-b and legs 106a-b.

The legs 106a and 106b include terminations (e.g., feet, tips, endings, or the like) contacting the ground. In one embodiment, the legs 106a and 106b each include a glider 118a and 118b, respectively. In other embodiments, the terminations can be plastic, metallic, etc. In some embodiments, the terminations can be wheels, rails, etc.

Furthermore, the legs 104a and 104b also include terminations contacting the ground. In some embodiments, such as depicted in FIG. 1A, the legs 104a and 104b can include terminations that are wheels. The terminations of the legs 104a-b and 106a-b can be configured to allow the collapsible walking device 100a to move freely while the user is walking and can provide resistance (e.g., via material of the feet or brakes on the wheels) to prevent the collapsible walking device 100a from moving while the user is standing. For example, one or both of the handles 102a-b may include a squeezable lever for a user to engage a braking system at the wheels 116a and/or 116b.

The handles 102a-b, the legs 104a-b and 106a-b, and the cross bars 108a-b are variously coupled by joints that may be pivotable and/or moveable. In particular, the leg 104a, the leg 106a, and the cross bar 108a, are each pivotably coupled to the joint 120a while the leg 104b, the leg 106b, and the cross bar 108b are each pivotably coupled to the joint 120b. A joint 122a pivotably and moveably couples the leg 104a, the stabilization bar 112a, and the cross bar 108b, a joint 122b pivotably and moveably couples the leg 104b, the stabilization bar 112b, and the cross bar 108a. Accordingly, the joint 122a may slide up and down along leg 104a and joint 122b may slide up and down along leg 104b. In embodiments wherein the collapsible walking device 100a includes stabilization bars 112a-b, a joint 124a pivotably (and in some embodiments also moveably) couples the leg 106a and the stabilization bar 112a, and a joint 124b pivotably (and in some embodiments also moveably) couples the leg 106b and the stabilization bar 108b. Accordingly, the joint 124a may slide up and down along leg 106a and joint 124b may slide up and down along leg 106b. In other embodiments, joint 124a is fixed at a location on leg 106a, and joint 124b is fixed at a location on leg 106b.

FIG. 1B is a perspective view of a collapsible walking device 100b in an operative configuration, according to one embodiment of the present disclosure. The collapsible walking device 100b may the same as or similar to the collapsible walking device 100a of FIG. 1A, except that the legs 104a and 104b are terminated in rubber feet (e.g., tips) 116c and 116d instead of wheels. Similarly, the legs 106a and 106b are terminated in rubber feet 118c and 118d. In some embodiments, the rubber feet 116c-d and 118c-d are identical. In other embodiments, the rubber feet 116c-d and 118c-d differ in one or more of their shape, material, size, etc. In some embodiments, the rubber feet 118c-d are the same or similar to the gliders 118a-b of FIG. 1A.

The some embodiments, the collapsible walking devices 100a-b are height adjustable. Each of the handles 102a-b may include a height adjustment mechanism to allow a user to increase or decrease the height to adjust the height of the collapsible walking device to a specific individual. In some embodiments, the handles 102a-b may include a telescoping height adjustment mechanism whereby a portion of the handle 102a-b is moveable within a portion of the leg 104a-b, respectively, and can be secured via a fastener 134a-b (e.g., spring button, a pressure tensioner, a screwing mechanism, or the like). In some embodiments, the height adjustment can be implemented in the legs 104a-b and/or the legs 106a-b, for example by similar means, such as a telescoping height adjustment mechanism.

FIG. 2 is a perspective view of a collapsible walking device 200 in a storage configuration, according to one embodiment of the present disclosure. Although not all components may be shown, the collapsible walking device 200 may be the same as or similar to the collapsible walking devices 100a-b of FIGS. 1A-B, as noted by similar reference numbers. The collapsible walking device 200 in the storage configuration is compact and allows the user to easily and conveniently transport and store the collapsible walking device 200. In the illustrated embodiment, the legs 104a-b are substantially parallel and the legs 106a-b are substantially parallel.

The collapsible walking device 200 may be placed into a storage configuration by moving the locking mechanism 130 from an extended position (as shown in FIGS. 1A-B) to a folded position (as shown in FIG. 2) by applying a force to the locking mechanism 130. In some embodiments, an upward force can be applied to the locking mechanism 130 to move the cross bar 110 from the extended position to the folded position. The upward force may be applied by applying the force to the handle 115 of the housing 114. The handle 115 may allow the user to apply the upward force more easily (and in some cases more safely, by protecting the user's hands, fingers, and or clothing from the gear mechanism). In some embodiments, rather than applying an upward force to the gear mechanism, a downward force may be applied to move the cross bar 110 from the extended position to the folded position. In other embodiments, a lateral (e.g., forward or backward) force may be applied to the gear mechanism to move the cross bar 110 from the extended position to the folded position. In each case, by causing the cross bar 110 to move from the extended position to the folded position, the collapsible walking device is transitioned from the operative condition (as in FIGS. 1A-B) to the storage configuration (as in FIG. 2).

In the storage configuration, the handles 102a-b, the legs 104a-b, and the legs 106a-b are positioned in proximity with each other. Furthermore, the cross bars 108a-b are pivoted at their intersection 126 such as to cause each to become more aligned with the legs 104a-b and 106a-b. The handles 102a-b, legs 104a-b and 106a-b, and cross bars 108a-b may be variously coupled by joints, such as joints 120a-b, 122a-b, and 124a-b, that allows the collapsible walking device 200 to be collapsed into the storage configuration.

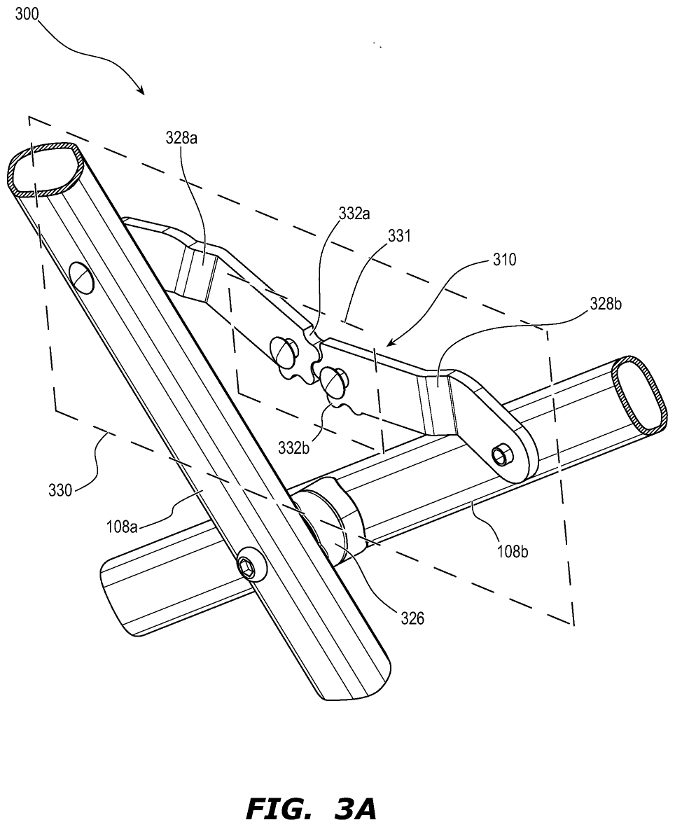

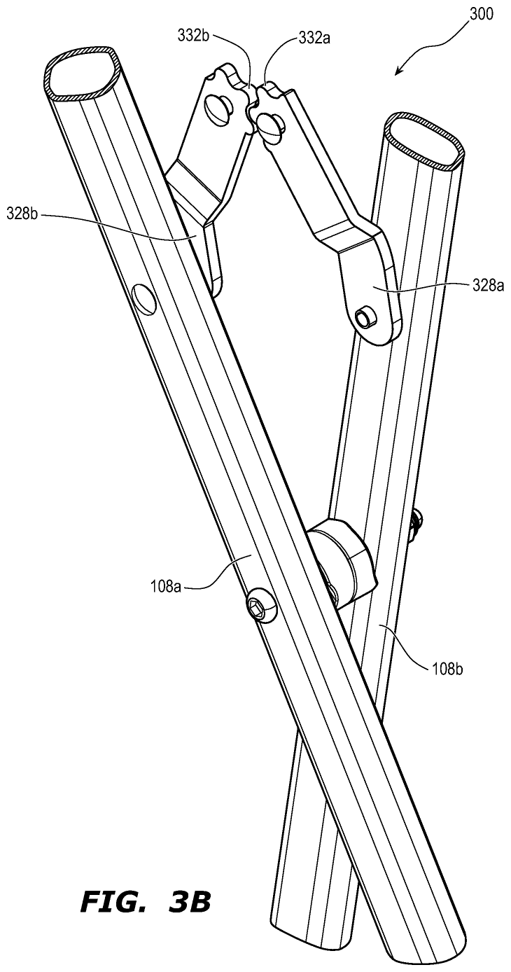

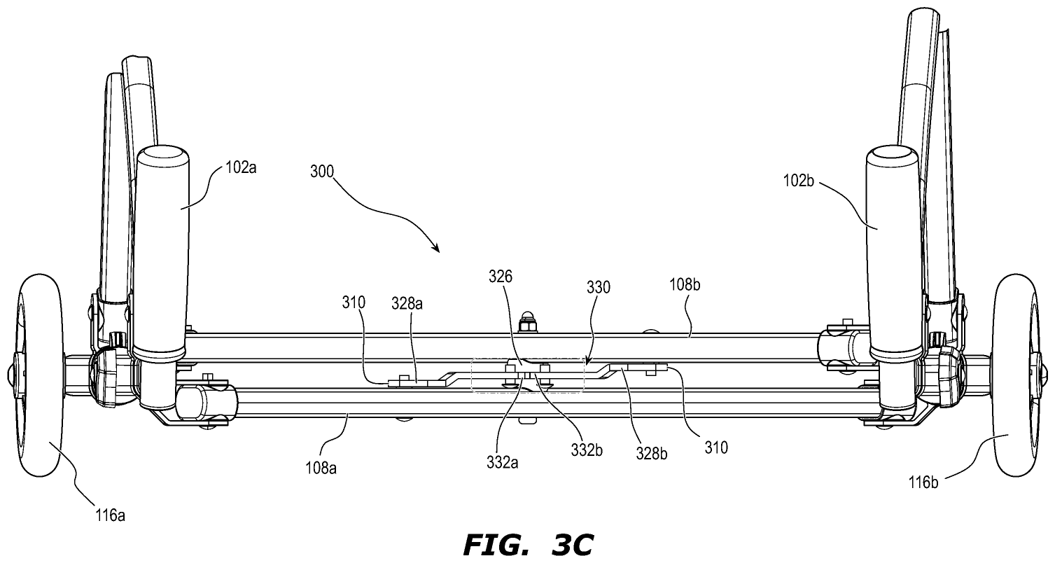

FIG. 3A is a perspective detailed view of a locking mechanism 330 of a collapsible walking device 300 in an operative configuration, according to one embodiment of the present disclosure. Although not all components may be shown, the collapsible walking device 300 may be the same as or similar to the collapsible walking devices 100a-b of FIGS. 1A-B, or any collapsible walking device described herein, as noted by similar reference numbers.

The locking mechanism 330 includes a cross bar 310. The cross bar 310 includes arms 328a and 328b, each arm 328a-b with a first end and a second end. The first end of each arm 328a and 328b are pivotably coupled to one of the cross bars 108a and 180b. For example, the first end of a first arm 328a is pivotably coupled to the cross bar 108a and a second arm 328b is pivotably coupled to the cross bar 108b. The second end of each first arm 328a and the second arm 328b are pivotably coupled by a gear mechanism 331. In the illustrated embodiment, the second end of the first arm 328a has a first gear 332a and the second end of the second arm 328b has a second gear 332b such that the first gear 332a and the second gear 332b are configured to mesh together.

In order to transition the collapsible walking device 300 between the operative configuration and the storage configuration, the gear mechanism 331 is movable from an extended position (see FIG. 3A) to a folded position (FIG. 3B illustrates the gear mechanism is a partially folded position), which subsequently moves the arms 328a-b from an extended position to a folded position, and which causes and/or allows the legs 104a-b, the legs 106a-b, and the cross bars 108a-b to move from the operative configuration to the storage configuration and/or from the storage configuration to the operative configuration.

When the collapsible walking device 300 is in the operative configuration, the gear mechanism 331 is configured to maintain the cross bar 310 in the extended position. When the collapsible walking device 300 is in the storage configuration, the gear mechanism 331 is configured to maintain the cross bar 310 in the folded position. The gear mechanism 331 includes gears 332a-b to assist a transition of the collapsible walking device 300 between the operative configuration and the storage configuration.

The cross bar 310 may be moved from the extended position (in which the collapsible walking device 300 is in the operative configuration) to the folded position (in which the collapsible walking device 300 is in the storage configuration) when an upward force (e.g., in a direction away from the ground) is applied to the gear mechanism 331 (or to the gears 332a and 332b). Although described herein as an upward force, in other embodiments, the force required to move the cross bar 310 between the extended position and the folded position may be in a downward, inward, or outward direction, or any combination thereof.

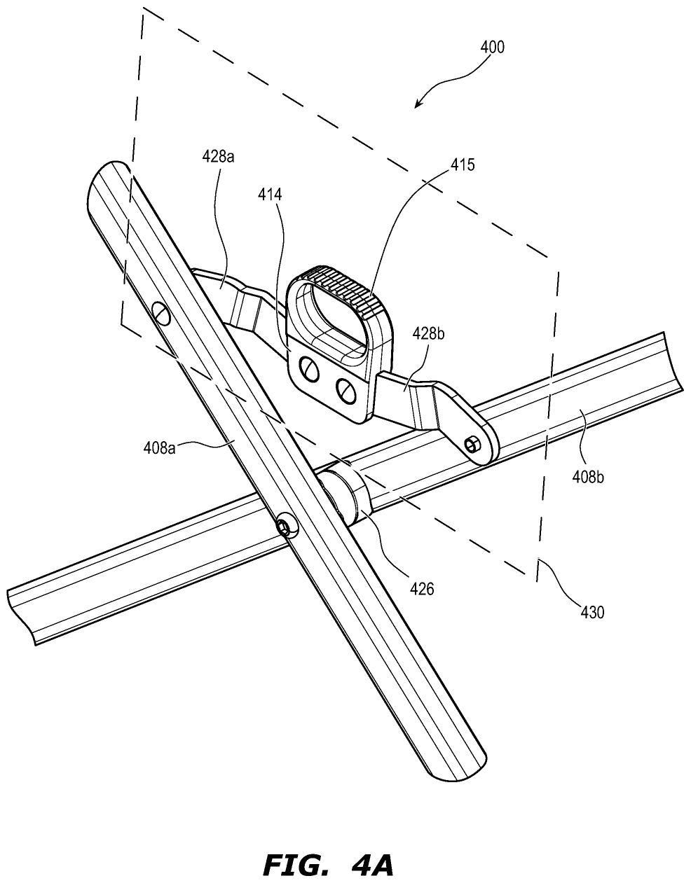

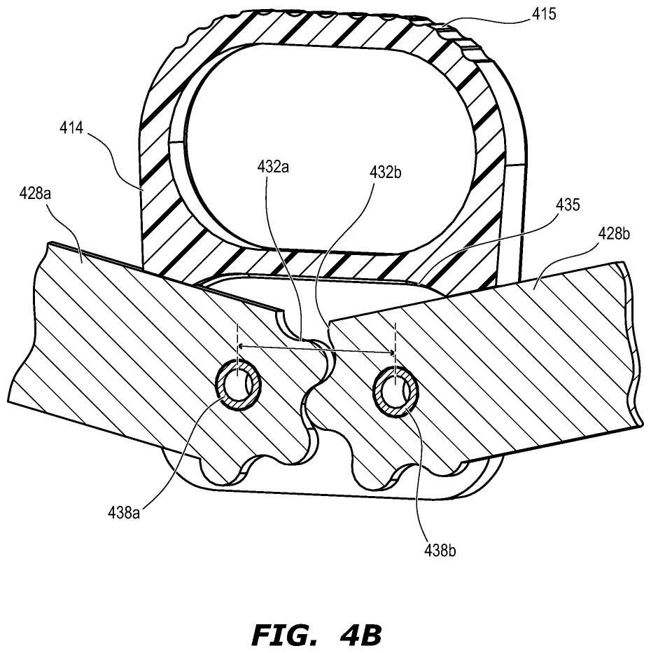

FIG. 3B is a perspective detailed view of the locking mechanism 330 of the collapsible walking device 300 transitioning from the operative configuration to a storage configuration, according to one embodiment of the present disclosure. In other words, the locking mechanism 330 is in a partially closed configuration and the gear mechanism 331 is an a partially folded position. When the predetermined force is applied to a handle (such as housing 414 of FIG. 4), the arms 328a-b of the cross bar 310 are transitioned from the extended position to the folded position. In the illustrated embodiment, the gears 332a-b of the arms 328a-b remain interlocked (e.g., meshed) during the transition from the extended position to the folded position and further remain interlocked in the folded position. In other embodiments, the gears 332a-b may become disengaged in the folded position while being engaged in the extended position and while transitioning. During the transition from the extended position to the folded position, the point at which the gears 332a-b are coupled remains above the rotatable joint 326 (e.g., intersection between the cross bars 108a-b). In the illustrated embodiment of FIG. 3B, the arms 328a-b are illustrated as angled relative to each other, however, the arms 328a-b may continue to transition to be substantially parallel to each other in the storage configuration.

FIG. 3C is a top view of the locking mechanism 330 of the collapsible walking device 300 in an operative configuration, according to one embodiment of the present disclosure. The arms 328a and 328b of the cross bar 310 are coupled to the cross bars 108a and 108b. The gears 332a-b of the arms 328a-b are meshed together in the operative configuration. The first end of each of the arms 328a and 328b are pivotably coupled to the cross bars 108a and 108b, respectively. In one embodiment, the first end of the arm 328a is coupled to an exterior side (e.g., toward the direction of the legs 104a-b and/or away from the user of the collapsible walking device 300) of the cross bar 108a, while the first end of the arm 328b is coupled to an interior side (e.g., toward the direction of the legs 106a-ab and/or toward the direction of the user of the collapsible walking device 300) of the cross bar 108b. In another embodiment, the first end of the arm 328a is coupled to an interior side of the cross bar 108a while the first end of the arm 328b is coupled to an exterior side of the cross bar 108b. In both cases, each of the arms 328a and 328b have a bend, such that the cross bar 310 forms a bend, and such that it does not exist in a single plane.

As further shown, the cross bar 108a may be located in a first plane, the cross bar 108b may be located in a second plane, substantially parallel to the first plane, and separated from the first plane by a distance, and the arm 328a may be coupled to the cross bar 108a in the first plane, and the arm 328b may be coupled to the cross bar 108b in the second plane.

In this way, the cross bar 310 provides a degree of rotational stability for the cross bars 108a-b. In other embodiments, the cross bar 310 does not form a bend, but the cross bars 108a and 108b each include a bend to accommodate the cross bar 310.

FIG. 4A is a perspective detailed view of a locking mechanism 430 of a collapsible walking device 400 in an operative configuration, according to one embodiment of the present disclosure. Although not all components may be shown, the collapsible walking device 400 may be the same as or similar to the collapsible walking devices 100a-b of FIGS. 1A-B, or any collapsible walking device described herein, as noted by similar reference numbers.

The locking mechanism 430 includes arms 428a and 428b of the cross bar 410. Each of the arms 428a and 428b include a gear (see gears 432a and 432b of FIG. 4B). The arm 428a is couplable to a cross bar 408a and the arm 428b is couplable to a cross bar 408b. The gears 432a-b of the arms 428a-b mesh together. In other words, the gear 432a of the arm 428a and the gear 432b of the arm 428b are mechanically coupled.

The locking mechanism 430 further includes a housing 414 which encompasses the gears 432a-b of the arms 428a-b. For example, the housing 414 can include an internal cavity to house the gears of the arms 428a-b. The locking mechanism 430 locks the arms 428a and 428b in an extended position (e.g., when the collapsible walking device 400 is in the operative configuration). A predetermined amount of force applied to the housing 414 can unlock the locking mechanism 430 and transition the arms 428a-b into a folded position (e.g., when the collapsible walking device 400 is in the storage configuration). In some embodiments, the predetermined amount of force is fixed at the time of manufacturing of the collapsible walking device 400 and/or the locking mechanism 430. In other embodiments, the predetermined amount of force may be adjustable (e.g., by the user via a dial, lever, or other setting) based on specific needs or requirements.

In some embodiments, the housing 414 may include a handle 415. In some embodiments, the housing 414 may include a loop, a ring, a pull-tab, a string, an extension/protrusion, or the like which facilitates the user to apply the force to unlock the locking mechanism 430. The housing 414 is positioned directly above the gears 432a-b of the arms 428a-b, such that when the force is applied to the housing 414, the arms 428a-b pivot (either to expand or fold) at the point about which the gears 432a-b mesh. When there is no external force applied to the housing 414, the housing 414 can selectively secure the gears 432a-b of the arms 428a-b in fixed positions (such as expanded or folded).

FIG. 4B is a perspective detailed view of a cross-section of gears 432a and 432b of the locking mechanism 430 within the housing 414, according to one embodiment of the present disclosure. The housing 414 includes an internal cavity 435 in which the gears 432a-b of the arms 428a-b are enclosed. In some embodiments, the internal cavity 435 may be a slot that extends upward from a bottom on the housing 414 from one lateral side of the housing 414 to the opposite lateral side of the housing 414, thus allowing the arms 428a-b to slide within the slot during rotation of the arms 428a-b from the extended position to the folded position and vice versa. The housing 414 may be mechanically coupled to the gears 432a-b via connectors 438a-b (e.g., pins, fasteners, bolts, rivets, or the like) which allows the gears 432a-b to rotate with respect to one another while a distance separating the connectors 438a and 438b remains fixed by the structural rigidity of the housing 414. By maintaining the distance separating the connectors 438a and 438b constant, teeth of the gears 432a and 432b remain meshed as the housing 414 transitions the arms 428a-b between the folded position and the extended position. In some embodiments, the gears 432a-b have a substantially circular profile (contoured by the teeth of the gears 432a-b), which allows the teeth of the gears 432a-b to remain in contact as the gears are rotated.

In some embodiments, the gears 432a-b are limited by a range of motion resulting from the fixed distance between the connectors 438a-b as well as the presence of the arms 428a-b. For example, when the arms 428a-b are in the extended position, which may be a result of applying a downward force on the housing 414, there may be a threshold position at which the gears 432a-b can no longer rotate and be meshed together, and may instead be locked in the extended position by the housing 414. For example, when the arms 428a-b are aligned in a substantially horizontal position, thereby achieving a maximum extended position. Similarly, when the arms 428a-b are in the folded position, which may be a result of applying an upward force on the housing 414, there may be a threshold position at which the gears 432a-b can no longer rotate, and may instead be locked in the folded position by the housing 414. For example, when the arms 428a-b are aligned in a substantially vertical position, thereby achieving a minimum distance between each other.

While specific embodiments of collapsible walking devices have been illustrated and described, it is to be understood that the disclosure provided is not limited to the precise configuration and components disclosed. Various modifications, changes, and variations apparent to those of skill in the art may be made in the arrangement, operation, and details of the methods and systems disclosed, with the aid of the present disclosure.

References to approximations are made throughout this specification, such as by use of the term “substantially.” For each such reference, it is to be understood that, in some embodiments, the value, feature, or characteristic may be specified without approximation. For example, where qualifiers such as “about” and “substantially” are used, these terms include within their scope the qualified words in the absence of their qualifiers. For example, where the term “substantially parallel” is recited with respect to a feature, it is understood that in further embodiments, the feature can have a precisely parallel configuration.

Similarly, in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. Moreover, the order of the steps or actions of the methods disclosed herein may be changed by those skilled in the art without departing from the scope of the present disclosure. In other words, unless a specific order of steps or actions is required for proper operation of the embodiment, the order or use of specific steps or actions may be modified. The scope of the invention is therefore defined by the following claims and their equivalents.

What is claimed is:

1. A collapsible walking device for providing mobility support to a user that is configured to be disposed in an operative configuration and a storage configuration, the collapsible walking device comprising:
a first handle and a second handle configured to support and be grasped by the user;
a first handle leg and a second handle leg that extend from the first handle and the second handle, respectively, the first handle leg and the second handle leg extending toward the ground and being configured to be forward of the user in the operative configuration;
a first support leg and a second support leg pivotably coupled to the first handle leg and the second handle leg, respectively, the first support leg and the second support leg extending toward the ground and being configured to extend toward the user in the operative configuration;
a first cross bar and a second cross bar, each being pivotably coupled to the first handle leg and the second handle leg, the first cross bar and the second cross bar intersect each other and are pivotably coupled to each other; and
a third cross bar pivotably coupled to the first cross bar and the second cross bar and being configured to selectively maintain a fixed angle between the first cross bar and the second cross bar in the operative configuration.

2. The collapsible walking device of claim 1, further comprising a first stabilization bar coupled to the first handle leg and the first support leg and a second stabilization bar coupled to the second handle leg and the second support leg.

3. The collapsible walking device of claim 1, further comprising a gear mechanism pivotably coupling a first arm and a second arm of the third cross bar.

4. The collapsible walking device of claim 3, wherein the gear mechanism is movable from an extended position to a folded position which causes the first and second handle legs, the first and second support legs, and the first and second cross bars to move from the operative configuration to the storage configuration.

5. The collapsible walking device of claim 3, wherein the gear mechanism is configured to maintain the third cross bar in an extended position in the operative configuration and to maintain the third cross bar in a folded position in the storage configuration.

6. The collapsible walking device of claim 1, further comprising a housing encompassing the gear mechanism.

7. The collapsible walking device of claim 4, wherein the gear mechanism is moved from the extended position to the folded position when a force is applied to the gear mechanism.

8. The collapsible walking device of claim 3, wherein a first end of the first arm of the third cross bar is coupled to an exterior side of the first cross bar and a first end of the second arm is coupled to an interior side of the second cross bar, wherein a second end the first arm comprises a first gear and a second end of the second arm comprises a second gear, and wherein the first gear and the second gear mesh together.

9. The collapsible walking device of claim 3, wherein the gear mechanism is disposed between an intersection of the first and second cross bars.

10. The collapsible walking device of claim 1, wherein the first support leg and the second support leg include a first rubber foot and a second rubber foot, respectively.

11. The collapsible walking device of claim 10, wherein the first handle leg and the second handle leg include a third rubber foot and a fourth rubber foot, respectively.

12. The collapsible walking device of claim 10, wherein the first handle leg and the second handle leg each include a wheel.

13. A collapsible walking device configured to be disposed in one of an operative configuration or a storage configuration, the collapsible walking device comprising:
a first lateral portion;
a second lateral portion;
a first cross bar and a second cross bar pivotably coupled at an axis of rotation, wherein the first cross bar and the second cross bar couple the first lateral portion to the second lateral portion; and
a locking mechanism coupled to the first cross bar and the second cross bar, the locking mechanism comprising:
a first arm including a first gear;
a second arm including a second gear mechanically coupled to the first gear; and
a housing configured to selectively secure the first gear and the second gear in a first fixed position when the collapsible walking device is in the operative configuration.

14. The collapsible walking device of claim 13, wherein the first lateral portion and the second lateral portion each comprise a handle, a handle leg that extends away from the handle, and a support leg that extends away from the handle leg.

15. The collapsible walking device of claim 13, wherein a force applied to the first gear and the second gear causes the collapsible walking device to transition between the operative configuration and the storage configuration.

16. The collapsible walking device of claim 13, wherein the first cross bar is disposed on a first plane and the second cross bar is disposed on a second plane, parallel to the first plane, and separated from the first plane by a distance, and wherein the first arm is coupled to the first cross bar in the first plane, and the second arm is coupled to the second cross bar in the second plane.

17. The collapsible walking device of claim 13, wherein the locking mechanism is disposed directly above the axis of rotation.

18. A locking mechanism for a collapsible walking device comprising:
a first arm including a first gear, the first arm being couplable to a first cross bar of the collapsible walking device;
a second arm including a second gear, the second arm being couplable to a second cross bar of the collapsible walking device, wherein the first gear and the second gear mesh together; and
a handle encompassing the first gear and the second gear,
wherein the locking mechanism selectively locks the first arm and the second arm in an extended position, and
wherein a predetermined amount of force applied to the handle unlocks the locking mechanism transitions the first arm and the second arm into a folded position.

19. The locking mechanism for the collapsible walking device of claim 18, wherein the handle is disposed directly above the first gear and the second gear.

20. The locking mechanism for the collapsible walking device of claim 18, wherein the handle comprises an internal cavity to house the first gear and the second gear.
